(19) United States
(12) Patent Application Publication
(10) Pub. No.: US 2026/0103919 A1
(43) Pub. Date: Apr. 16, 2026

(54) SINGLE CABLE POWER CINCH AND ICE BREAKER LATCH

(71) Applicant: MAGNA CLOSURES INC., Newmarket (CA)

(72) Inventor: Francesco CUMBO, Newmarket (CA)

(21) Appl. No.: 19/350,304

(22) Filed: Oct. 6, 2025

Related U.S. Application Data
(60) Provisional application No. 63/706,243, filed on Oct. 11, 2024.
(60) Provisional application No. 63/770,191, filed on Mar. 11, 2025.

(51) Int. Cl. E05B 77/34; E05B 79/20; E05B 81/14; E05B 81/20

(52) U.S. Cl. CPC E05B 77/34; E05B 79/20; E05B 81/14; E05B 81/20

(57) ABSTRACT

A latch assembly for a closure panel includes a latch mechanism having a pawl moveable from a ratchet holding position to a ratchet releasing position to cause a ratchet to move from a striker capture position, whereat the ratchet is in latched engagement with a striker to maintain the closure panel in a closed position, to a striker releasing position out of latched engagement from the striker to allow the closure panel to be moved from the closed position to an open position. At least one lever is operable during a cinching operation to cinch the ratchet to the striker capture position, and during an ice breaking/presenting operation, to present the ratchet to the striker releasing position.

### CROSS-REFERENCE TO RELATED APPLICATIONS

This application claims the benefit of U.S. Provisional Application Ser. No. 63/770,191, filed Mar. 11, 2025, and of U.S. Provisional Application Ser. No. 63/706,243, filed Oct. 11, 2024, which are both incorporated herein by reference in their entirety.

### FIELD

The present disclosure relates generally to vehicle latches. More particularly, this disclosure is directed to a vehicle latches having power cinch and ice breaker mechanisms.

### BACKGROUND

This section provides background information related to automotive door latches and is not necessarily prior art to the concepts associated with the present disclosure.

It is known provide modern motor vehicle doors having a latch system including a latch assembly including a cinch mechanism and a separate ice breaker mechanism. Although such latch systems are suitable to perform the desired cinching and ice breaking functions, one draw back of such known latch systems is having to incorporate separate cables and associated drive gears and/or levers to operate the separate cinching and ice breaking mechanisms. Further, the aforementioned issues lead to an increased package size requirement and complexity of design, manufacture, assembly, and operation, thereby inhibiting design flexibility and increasing cost.

Accordingly, there remains a need to develop alternative arrangements for latch mechanisms for use in vehicular door latches which optimize the ability to move a ratchet to a striker capture position and to a striker releasing position under the power of a powered motor, while enhancing design flexibility, reduce the number of components and package size, while also reducing cost associated with vehicle door latches.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

In accordance the above objects, and in accordance with one non-limiting aspect of the present disclosure, a latch assembly for a closure panel of a motor vehicle, comprising: a latch mechanism having a pawl moveable from a ratchet holding position to a ratchet releasing position to cause a ratchet to move from a striker capture position, whereat the ratchet is in latched engagement with a striker to maintain the closure panel in a closed position, to a striker releasing position out of latched engagement from the striker to allow the closure panel to be moved from the closed position to an open position; and at least one lever operable during a cinching operation to facilitate cinching the ratchet to the striker capture position and during an ice breaking operation to present the ratchet to the striker releasing position.

In accordance with another aspect of the disclosure, the at least one lever is configured to move between a home position, whereat a link is moved to a first position for operable engagement with the ratchet to cinch the ratchet to the striker capture position, and a deployed position, whereat the link is moved to a second position in decoupled relation from the ratchet.

In accordance with another aspect of the disclosure, the latch assembly further includes a cable operably coupled to the link.

In accordance with another aspect of the disclosure, the latch assembly further includes a cinch/present lever coupled to the link, wherein the cable is directly coupled to the cinch/present lever.

In accordance with another aspect of the disclosure, the latch assembly further includes a present lever operably coupled to the ratchet, wherein the cinch/present lever is arranged to operably drive the present lever and cause the ratchet to move to the striker releasing position.

In accordance with another aspect of the disclosure, the present lever is coupled to the ratchet by a cable.

In accordance with another aspect of the disclosure, the link has a first drive feature configured for driving engagement with the present lever.

In accordance with another aspect of the disclosure, the link has a second drive feature configured drive the ratchet to the striker capture position.

In accordance with another aspect of the disclosure, the link is pivotal relative to the cinch/present lever between a home position, whereat the second drive feature is positioned to drive the ratchet to the striker capture position, and a deployed position, whereat the first drive feature is positioned for driving engagement with the present lever.

In accordance with another aspect of the disclosure, the link is biased toward the home position by a biasing member.

In accordance with another aspect of the disclosure, the cinch/present lever is arranged in driving engagement with the present lever.

In accordance with another aspect of the disclosure, the cinch/present lever and the present lever each have teeth arranged in meshed engagement with each other.

In accordance with another aspect of the disclosure, the latch assembly further includes a coupling link configured to act on the ratchet to present the ratchet to the striker releasing position.

In accordance with another aspect of the disclosure, the present lever has a slot and the coupling link has a drive member disposed in the slot for lost motion with the slot between a misaligned, disengaged position relative to a driven shoulder of the ratchet and into an aligned, engaged position with the driven shoulder of the ratchet.

In accordance with another aspect of the disclosure, the link has a drive member configured for movement between a coupled position, whereat drive member is positioned for operable engagement with the ratchet to drivingly move the ratchet to the striker capture position, and a decoupled position, wherein drive member moved out from operable engagement with the ratchet.

In accordance with another aspect of the disclosure, the drive member of the link is provided as a hook-shaped end of link.

In accordance with another aspect of the disclosure, the at least one lever has a drive member configured for driving engagement with a driven surface of the link to move the drive member out from operable engagement with the ratchet.

In accordance with another aspect of the disclosure, the drive member is a protrusion extending laterally from the at least one link and the driven surface is an elongate ledge extending laterally from the link.

In accordance with another aspect of the disclosure, the at least one lever is configured for direct engagement with the pawl to move the pawl from the ratchet holding position to the ratchet releasing position.

In accordance with another aspect of the disclosure, the latch assembly further includes a power release gear having a first cam operable to drive the at least one lever into direct engagement with the pawl to move the pawl from the ratchet holding position to the ratchet releasing position, and a second cam operable to drive the coupling link between the misaligned, disengaged position relative to a driven shoulder of the ratchet and the aligned, engaged position with the driven shoulder of the ratchet.

In accordance with another aspect of the disclosure, a method of cinching a ratchet of power latch assembly of a closure panel of a motor vehicle toward a striker capture position and presenting the ratchet toward a striker releasing position is provided. The power latch assembly includes a pawl configured for movement between a ratchet holding position, whereat the pawl maintains the ratchet in the striker capture position, and a ratchet releasing position, whereat the pawl releases the ratchet for movement of the ratchet to the striker release position. The method includes actuating a power actuator operably coupled to the ratchet and moving the ratchet toward the striker capture position, and actuating the power actuator operably coupled to the ratchet and moving the ratchet toward the striker releasing position.

In accordance with another aspect of the disclosure, the method further includes operably coupling the power actuator to the ratchet with a single cable and a plurality of levers, wherein some of the plurality of levers function to move the ratchet toward the striker capture position during the cinching operation and some of the plurality of levers function to move the ratchet toward the striker releasing position during the presenting operation.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 is a perspective view of a vehicle door of a motor vehicle equipped with a closure latch assembly in accordance with one aspect of the disclosure;

FIG. 2 is a side view of a latch mechanism of the closure latch assembly of FIG. 1 illustrating the latch mechanism operably coupled for communication with a power actuator and a single cable, with the latch mechanism shown in a primary latched state;

FIG. 3 is a view similar to FIG. 2 illustrating the power actuator activated to rotate a power release cam to abut an override lever and a pawl to move the pawl from a primary ratchet holding position to a ratchet releasing position and with a cable being pulled to move a cinch lever and cinch link that is pivotably coupled to the cinch lever along with an ice breaker lever that is configured in driving engagement with the cinch lever;

FIG. 4 is a view similar to FIG. 3 illustrating continued movement of the power release cam and the cable, with the ice breaker lever being continually driven by the cinch lever into forcible engagement with the ratchet to bias the ratchet from a striker capture position toward a striker release position;

FIG. 5 illustrates the latch mechanism in a fully unlatched state, whereat the ratchet is in the striker release position;

FIG. 6 illustrates the power actuator returned to a home position, whereat a spring returns a coupling link to a home position and the cinch lever is reset via the cable being deactivated;

FIG. 7 illustrates the striker returning the ratchet toward a secondary striker capture position, whereat the override lever is returned to a home position and the cinch link is biased into engagement with the ratchet;

FIG. 8 illustrates the cable acting on the cinch lever, which causes the cinch link to forcibly engage and drive the ratchet to a primary striker capture position, whereat the pawl returns to a primary ratchet holding position to releasably maintain the latch mechanism in the primary latched state of FIG. 2;

FIG. 9 is a back perspective view of a power latch assembly embodying the teachings of the present disclosure in accordance with another aspect of the disclosure shown with a ratchet in a striker capture position and with some components removed for clarity purposes only;

FIG. 10 is a back side elevation view of the power latch assembly of FIG. 9 with the ratchet in the striker capture position and with a cinch override link moved to a cinch override position;

FIGS. 11-14 are similar views to FIG. 10 illustrating a progression of a presenting operation to move the ratchet from a striker capture position toward a striker release position;

FIG. 15 is a back side elevation view of the power latch assembly of FIG. 9 with the ratchet shown in a secondary striker capture position and with the cinch override link moved to a cinch position;

FIGS. 16-19 are similar views to FIG. 15 illustrating a progression of a cinching operation to move the ratchet from the secondary striker capture position to a primary striker capture position; and

FIG. 20 is a view similar to FIG. 19 showing the cinch override link moved from the cinch position (phantom) to the cinch override position (solid).

Corresponding reference numerals are used throughout all of the drawings to indicate corresponding parts.

### DETAILED DESCRIPTION OF PRESENTLY PREFERRED EMBODIMENTS

An example embodiment of a motor vehicle closure panel and a latch assembly therefor will now be described more fully with reference to the accompanying drawings. To this end, the example embodiment of a latch assembly is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

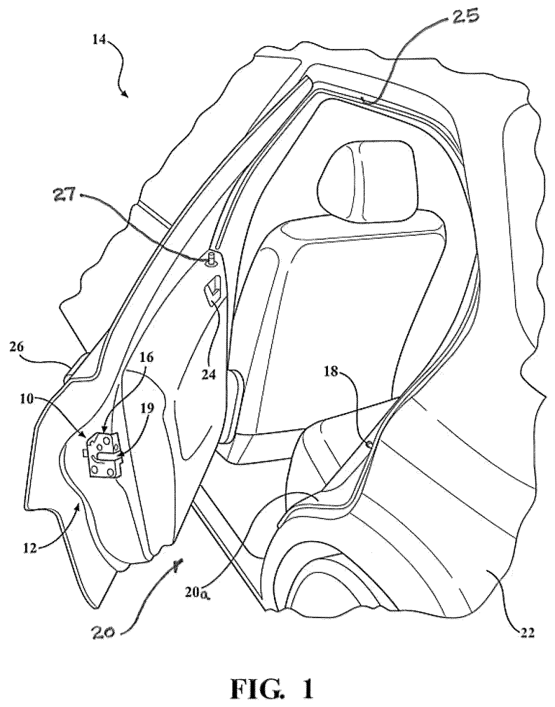

Now referring to FIG. 1, there is shown a motor vehicle 14, having a closure panel 12, shown as a rear passenger swing door, by way of example and without limitation, and referred to as vehicle door or simply door, for closing of an opening, such as a doorway 20, formed in a vehicle body 22. A power closure latch assembly, referred to hereafter as latch assembly 10, is provided on the door 12 to engage a striker 18 fixedly attached to the vehicle body 22, such as to a side sill or face 20a of door way 20, to retain the door 12 in a closed, latched state against a seal 25 provided on the vehicle body 12 and extending about the doorway 20. The latch assembly 18 is shown provided at least on a vertically extending shut face 16A of the door 16. An outside actuation mechanism, shown as an outside door handle 21, by way of example and without limitation, may be used to release the latch assembly 18 either mechanically or electrically from a locked and latched state to an unlocked and unlatched state, thereby allowing door 16 to be moved from a closed position to an open position. Similarly, an inside actuation mechanism, shown as an inside door handle 24, by way of example and without limitation, may be used to release the latch assembly 10 from the latched state to the unlatched state. A lock 27 may be used to control the state of the latch assembly 10 between locked and unlocked states.

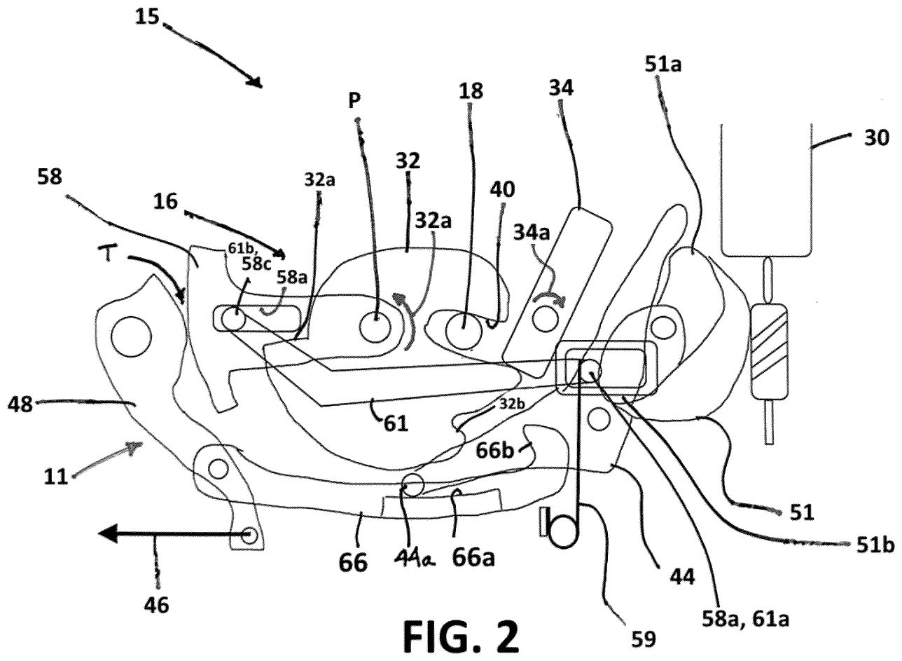

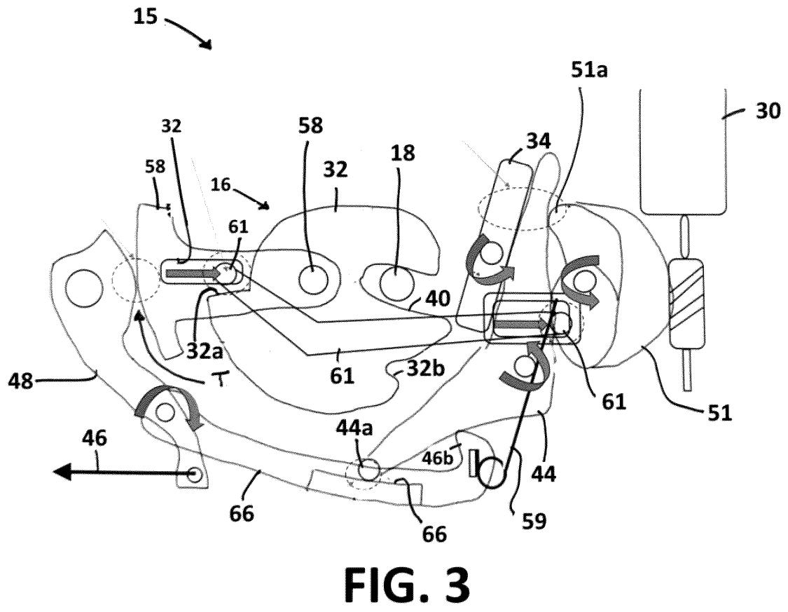

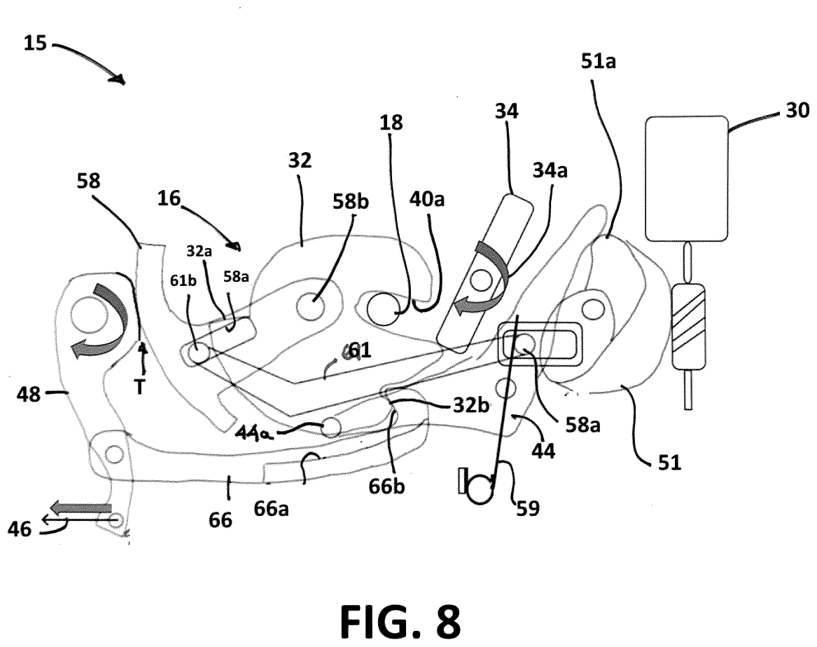

Now referring to FIG. 2, latch assembly 10 is illustrated and includes a strength module, also referred to as latch 15. Latch 15 has a latch mechanism 16 operable via a single electric power release actuator, also referred to as power release motor, latch motor or motor 30, as well as mechanically via outside door handle 26 and inside door handle 24. Latch motor 30 is operably coupled to latch mechanism 16 via a power release gear 51 having a first cam 51a, wherein first cam 51a is operable to drive a cinch/present link, also referred to as override lever 44, which facilitates both a presenting operation and a cinching operation, depending on the position, i.e. home or deployed position, of override lever 44, as discussed hereafter. Override lever 44 is operable to drive a cinch lever, also referred to as cinch link 66 between a first position, also referred to as home position (FIGS. 2, 7, and 8) and a second position, also referred to as deployed position (FIGS. 3-6), and a pawl 34. Power release gear 51 can be driven by latch motor 30 upon selective powered actuation of latch motor 30 for powered actuation of latch assembly 10, as desired, such as to actuate a cinch/present mechanism 11, discussed in more detail below. Latch mechanism 16 includes pawl 34, which is moveable from a ratchet holding position (FIGS. 2 and 8) to a ratchet releasing position (FIGS. 3 through 7) to cause a ratchet 32 to move from a striker capture position, whereat the ratchet 32 is in latched engagement with the striker 18 to maintain the closure panel 12 in a closed position, to a striker releasing position out of latched engagement from the striker 18 to allow the closure panel 12 to be moved from the closed position to an open position. Pawl 34 is biased by a pawl biasing member, such as a pawl spring 34a, toward the ratchet holding position. Ratchet 32 is biased by a ratchet biasing member 32a, such as a ratchet spring, toward the striker releasing position.

In FIG. 3, latch motor 30 is energized, thereby driving first cam 51a into driving engagement with override lever 44, thereby pivotably moving override lever 44 from the home cinching position to the deployed presenting position, which in turn moves into direct driving engagement with pawl 34 to rotate pawl 34 against the bias of pawl biasing member 34a from the ratchet holding position to the ratchet releasing position. During movement of override lever 44, a drive member 44a of override lever 44, shown as a laterally extending protrusion or pin, is also brought into driving engagement with a driven surface 66a, shown as a laterally extending protrusion, such as an elongate ledge of cinch link 66, which moves cinch link 66 from the first position to the second position, thereby moving a drive member 66b, shown as a hook-shaped end, of cinch link 66 to a decoupled position spaced away from ratchet 32 such that cinch link 66 is decoupled from the ratchet 32, and thus, moved out from operable engagement with the ratchet (32). Further, a single cable 46 is operably coupled to the cinch link 66, with cable 46 shown as being coupled directly to a cinch/present lever 48, also referred simply as present lever or cinch lever, depending on the operation being performed, such that when cable 46 is pulled, present/cinch lever 48 is pivotably driven clockwise, as shown in FIG. 3, into driving engagement, shown as being in driving engagement with an ice breaker/present lever 58, also referred to simply as ice breaker lever or present lever, via meshed teeth T, also referred to as a geared interface, of the present/cinch lever 48 and ice breaker lever 58, thereby causing ice breaker lever 58 to rotate counterclockwise in response to driving movement of present/cinch lever 48, as shown in FIG. 3. Ice breaker lever 58 is operably coupled to the ratchet 32, and is shown, by way of example and without limitation, coupled for pivotal rotation about a common pin P also supporting ratchet 32 for pivotal movement. Also, as power release gear 51 is driven counterclockwise, as shown in FIG. 3, a second cam 51b of power release gear 51 is moved away from a driven member 58b, shown as a pin, of an ice breaker coupling link, also referred to as coupling link 61, to allow coupling link 61 to be biased by a biasing member, shown as a torsion spring 59, to the right, as viewed in FIG. 3. As coupling link 61 is urged to the right, a drive member 61b, shown as a pin, of coupling link 61 is disposed in a slot 58a of ice breaker 58 and is caused to move in lost motion within slot 58a, whereupon drive member 61b is moved from a misaligned, disengaged position relative to a driven shoulder 32a of ratchet 32 into an aligned, engaged relation with driven shoulder 32a of ratchet 32.

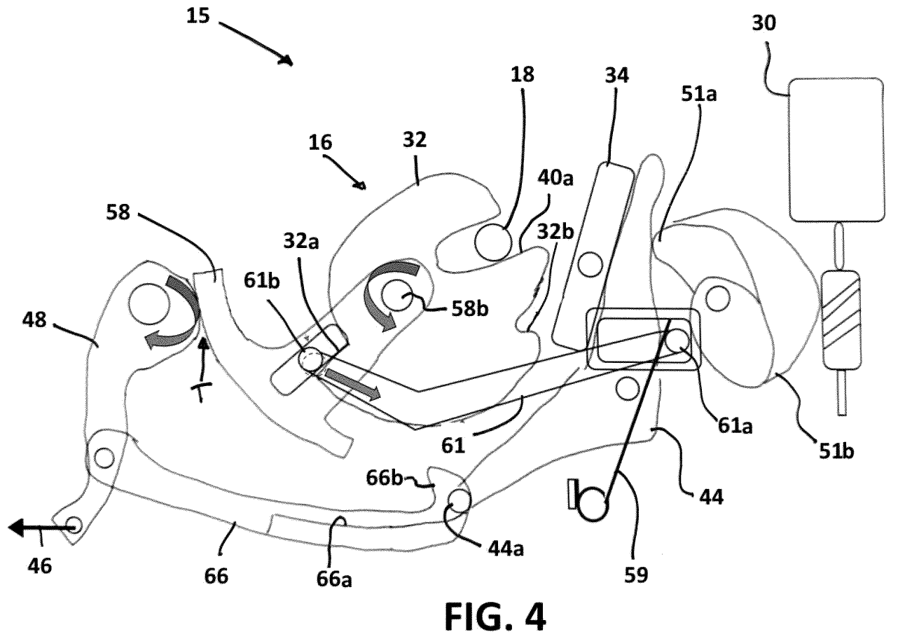

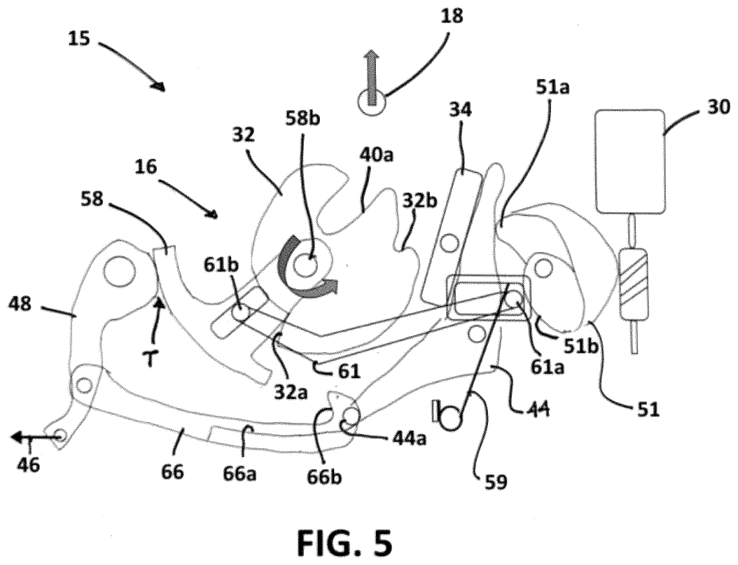

In FIG. 4, continued rotation of present/cinch lever, and in this case functioning as a present or ice lever 48, in the clockwise direction, as shown in FIG. 4, drives ice breaker lever 58 in the counterclockwise direction, thereby causing drive member 61b to drive driven shoulder 32a of ratchet 32, and thus, cause ratchet 32 to be forcibly driven from the striker holding position toward the striker release position. Accordingly, any resistance tending to restrict movement of ratchet 32 toward the striker release position is overcome, such as may occur from a buildup of ice on or about ratchet 32 or elsewhere in latch assembly 10. In FIG. 5, latch mechanism 16 is shown in a fully released and unlatched state, whereat ratchet 32 is in the striker release position, with striker 18 shown removed therefrom.

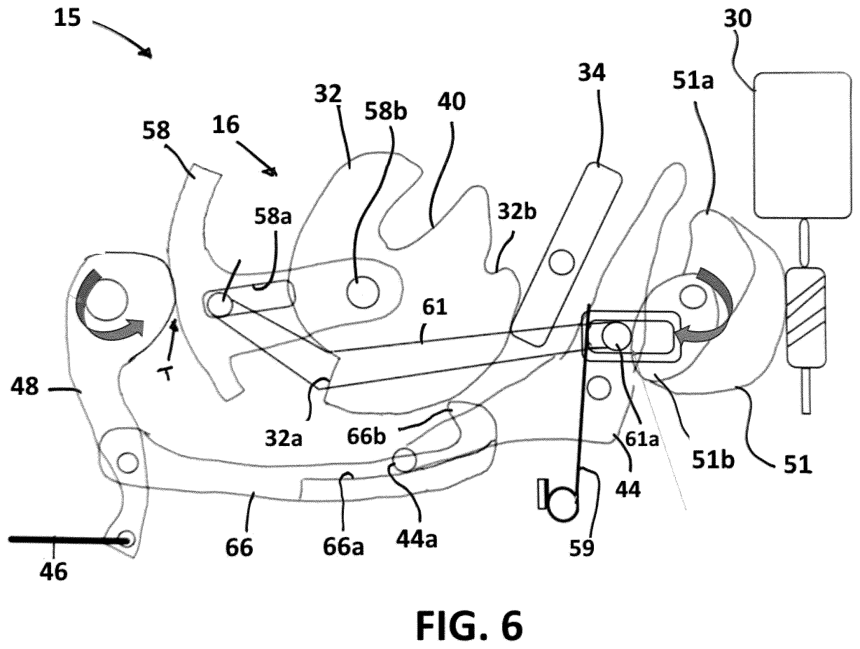

In FIG. 6, latch motor 30 is again energized, but in an opposite direction to that of FIG. 3, thereby driving power release gear 51 in an opposite, clockwise resetting direction and first cam 51a away from and out of engagement with override lever 44. As first cam 51a moves away from and out of engagement from override lever 44, override lever 44 returns from its deployed position to its home position, whereat cinch link 66 is allowed to return under bias imparted by biasing member 59 into engagement with ratchet 32. During return of power release gear 51 to the home position, second cam 51b forcibly urges driven member 61a of coupling link 61, thereby driving coupling link 61 to the left, as viewed in FIG. 6, against the bias imparted by biasing member 59, whereat drive member 61b of coupling link 61 is moved into its misaligned, disengaged position relative to shoulder 32a of ratchet 32. Cinch lever 48 is reset via cable 46 being deactivated.

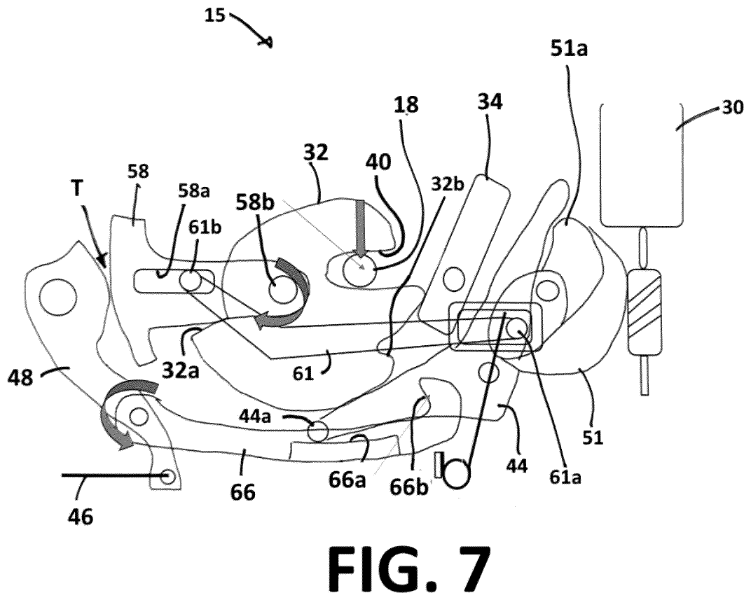

In FIG. 7, striker 18 is illustrated being returned into a striker slot 40 of ratchet 32, thereby causing ratchet 32 to return toward its primary striker capture position, or at least to a secondary striker capture position located between the striker release position and the primary striker capture position. Then, as shown in FIG. 8, with ratchet 32 in the secondary striker capture position, a cinching operation can be performed, wherein cable 46 is activated (tensioned) to pivot present/cinch lever 48 clockwise, and in this case functioning as a cinch lever 48, thereby pulling cinch link 66, which is pivotably coupled to cinch lever 48, and bringing drive member 66b of cinch link 66 into driving engagement with a driven cinch surface 32b of ratchet 32 while drive member 66b is in a coupled position. Cable 46 pulls on cinch lever 48, which causes drive member 66b of cinch link 66 to rotate ratchet 32 in a clockwise direction, as viewed in FIG. 8, until pawl 34 is biased by a pawl biasing member 34a back into its primary ratchet holding position.

Accordingly, in view of the above, a cinch and ice breaking/presenting operation is able to be performed via the single cable 46 and single motor 30. Further, a power release operation by motor 30 can be performed from any position of a cinch mechanism provided by cinch lever 48 and cinch link 66, including during a cinching process, via coordination of movement between power release gear 51, override lever 44, pawl 34, cinch link 66 and cinch lever 48. Further yet, a mechanical release operation of latch assembly 10 can be performed, even during a cinching operation, as will be understood by a person possessing ordinary skill in the art of latch systems, in view of the disclosure herein.

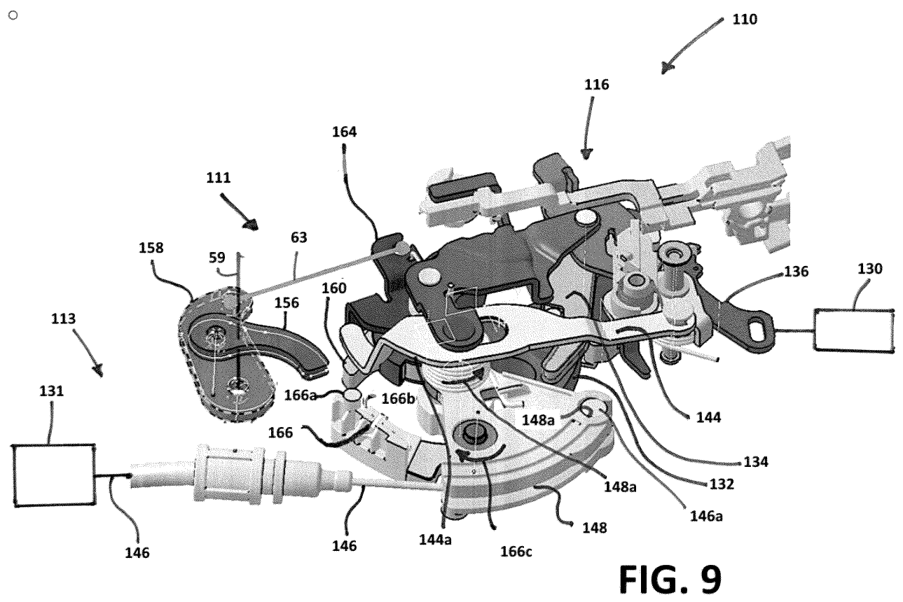

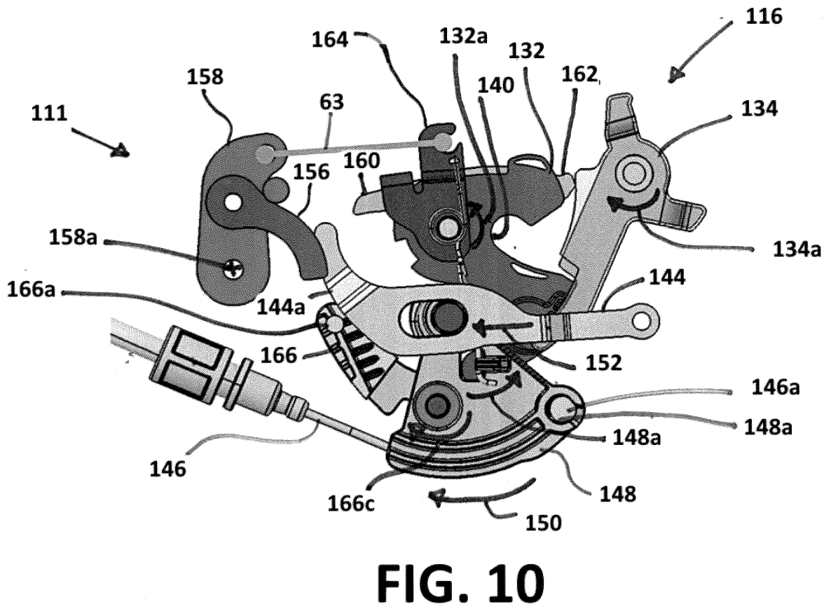

Referring to FIG. 9, shown is another non-limiting embodiment of latch assembly 110 and latch mechanism 116, wherein the same reference numerals as used above, offset by a factor of 100, are used to identify like or similar features. Latch mechanism 116 includes a ratchet 132 and a pawl 134, and a release lever 136. Ratchet 132 is movable between a primary striker capture position, whereat ratchet 132 retains striker 18 with a striker slot 140 of ratchet 132 and swing door 12 in a fully closed position, a secondary striker capture position, whereat ratchet 132 retains striker 18 within striker slot 140 to hold swing door 12 in a partially closed/partially open position, and a striker release position, whereat ratchet 132 permits release of striker 18 from a fishmouth 19 (FIG. 1) provided by latch housing of latch assembly 110 to allow movement of swing door 12 to the open position. A ratchet biasing member 132a (shown schematically in FIG. 10), such as a spring, is provided to normally bias ratchet 132 toward its striker release position. Pawl 134 is movable between a ratchet holding position, whereat pawl 134 holds ratchet 132 in its striker capture position, and a ratchet releasing position whereat pawl 134 permits ratchet 132 to move to its striker release position. A pawl biasing member 134a (shown schematically in FIG. 10), such as a suitable spring, is provided to normally bias pawl 134 toward its ratchet holding position.

Latch assembly 110 includes a cinch/present mechanism 111 operable via actuation of a single actuator/cable arrangement 113, and can be selectively actuated for release via inside door handle 24, outside door handle 26, and/or remotely via a key fob. As detailed hereafter, latch assembly 110 is configured to be power-operated via selective actuation of a power release actuator, also referred to as power actuator, such as an electric motor, and referred to hereafter as motor 130, in combination with a single cinch/present power actuator 131.

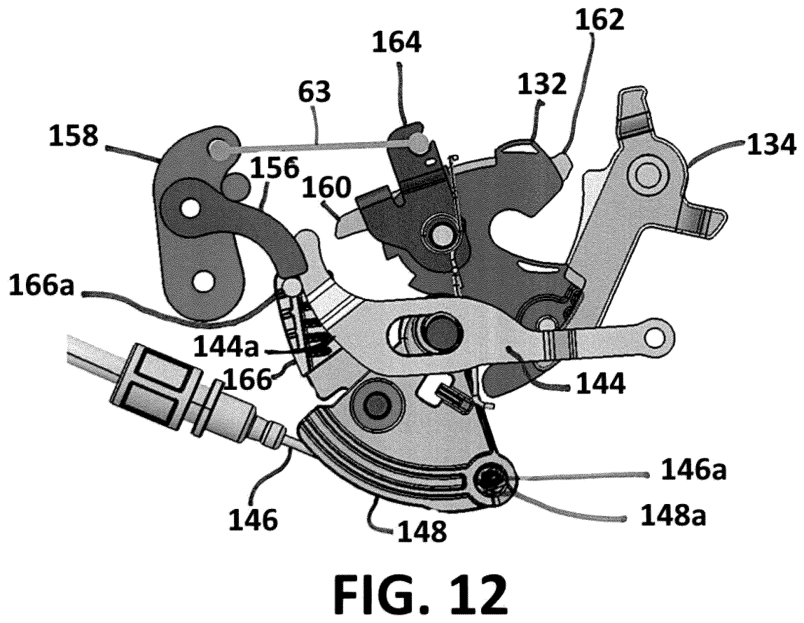

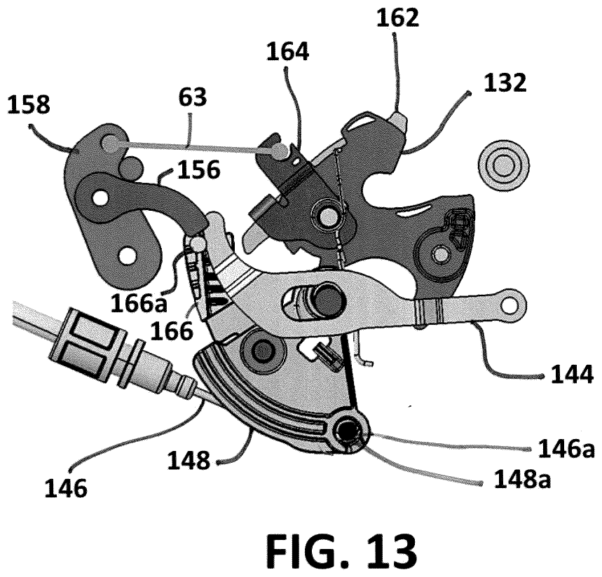

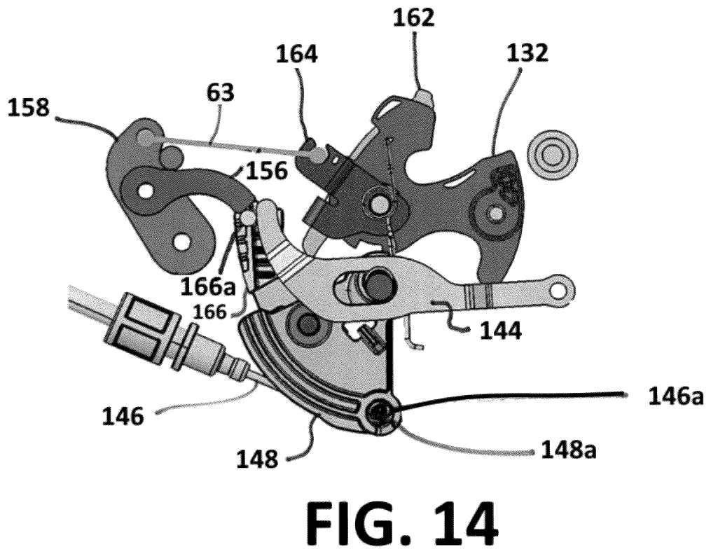

Cinch/present mechanism 111 includes a cinch/present link, also referred to as coupling lever 144, that facilitates both a presenting operation and a cinching operation, depending on the position, i.e. home or deployed position, of coupling lever 144, as discussed hereafter. Coupling lever 144 is urged against a bias, with bias being imparted to locate coupling lever 144 in a home cinching position, to a deployed presenting position, also referred to as ice breaking position (FIG. 10). With coupling lever 144 in the presenting position (FIGS. 10-14), cinch/presenter actuator 131 is energized, such as in response to a signal from ECU, by way of example and without limitation, whereupon actuator 131 of cinch/presenter mechanism 111 presents the ratchet 132 toward the striker releasing position in a presenting operation. It is to be understood this same process is effective to free ratchet 132 from any friction tending to prevent ratchet 132 from moving under the bias of ratchet biasing member 132a, such as ice, thereby being effective as an ice breaking operation.

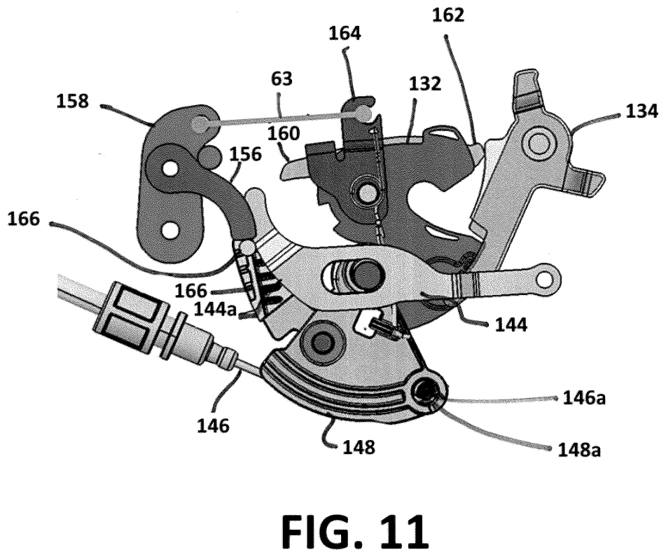

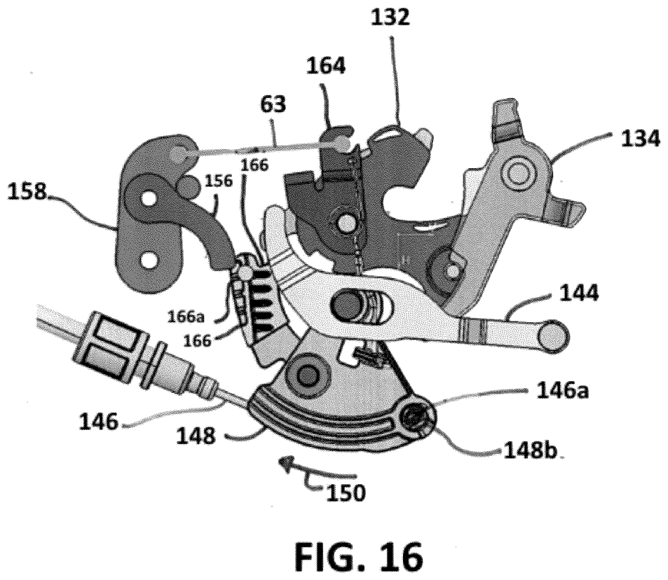

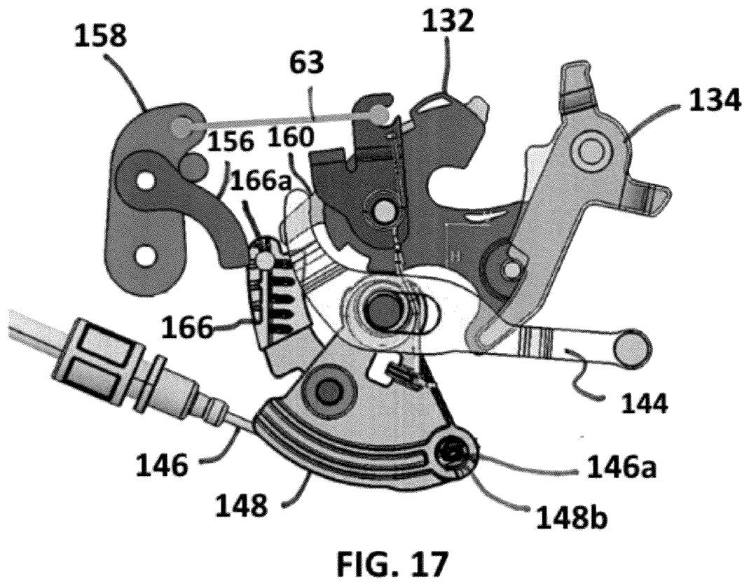

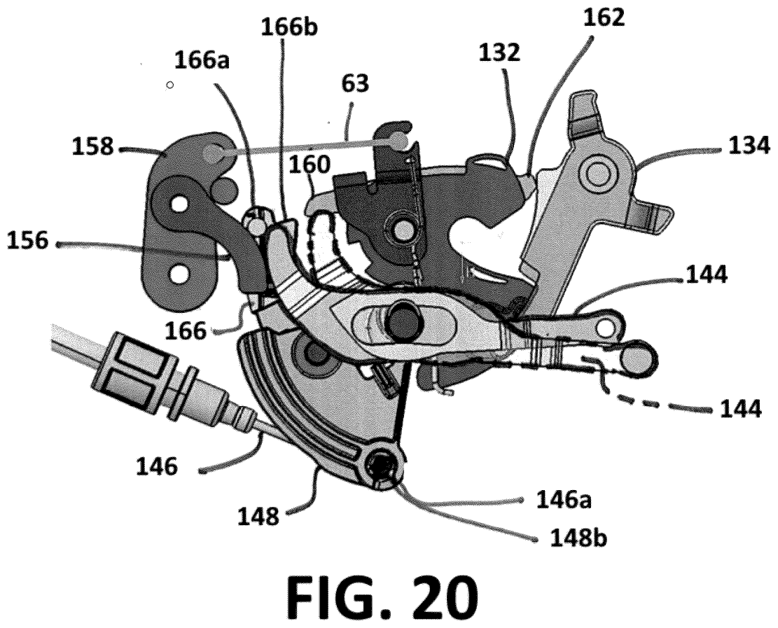

During activation of cinch/present actuator 131 in a presenting operation, in the non-limiting embodiment illustrated, a single cable 146 connected to an actuation lever, also referred to as cinch/present lever 148, is pulled under tension and drivingly pivots cinch/present lever 148 in direction of arrow 150 (FIG. 10) against a bias imparted on cinch/present lever 148, such as via a spring member, shown schematically by arrow 148a in FIG. 10, thereby operably causing a concurrent driving movement of coupling lever 144 generally along a direction indicated by arrow 152, such as via energization of actuator 130. With coupling lever 144 urged laterally, a drive lug, also referred to as first drive feature or drive pin 166a fixed to a cinch/present drive arm or lever or link, or simply drive arm, drive lever, or link 166, pivotably coupled to and extending from cinch/present lever 148, engages a peripheral arcuate surface 144a of coupling lever 144 and is pivotably urged and guided into alignment by the arcuate surface 144a for engagement with a drive feature, such as an extension, also referred to as arm 156, of an ice breaking/present lever, also referred to as ice breaking lever or present lever 158 of cinch/present mechanism 111. Arm 156 is fixed to present lever 158, such that they pivot conjointly with one another about a present lever axis 59 (FIG. 9). Arm 156 and present lever 158 can be formed of separate pieces of material and be fixed together, or they can be formed as a monolithic piece of material, if desired. Accordingly, cinch/present lever 148) is arranged to operably drive the present lever 158 during the presenting operation and cause the ratchet 132 to move to the striker releasing position, as discussed further hereafter. Drive lever 166 is biased toward a first position, also referred to as home position, by a drive arm biasing member, shown schematically by arrow 166c, whereupon the engagement of drive pin 166a with arcuate surface 144a overcomes the bias imparted by biasing member 166c to cause pivotal movement of drive arm 166 relative to cinch/present lever 148. At the same time drive arm 166 is pivoted away from its home position against the bias of biasing member 166c to a second position, also referred to as deployed position, a drive surface, also referred to as second drive feature or drive shoulder 166b, of drive lever 166 is moved out of alignment from a drive feature, such as an drive extension, also referred to as drive arm 160, of a cinch/present driven lever 162 of cinch/present mechanism 111, and thus, drive lever 166 is decoupled from operable engagement with ratchet 132. As the presenting operation continues, drive pin 166a forcibly engages arm 156, and thus, present lever 158 is rotatably driven about a present lever axis 158a defined by a present lever pin, thereby rotatably driving a ratchet drive member, also referred to as ratchet drive lever 164, operably coupled to ratchet 132, to forcibly drive ratchet 132 rotatably toward the striker releasing position to overcome any friction/obstruction otherwise preventing ratchet 132 from moving to the striker releasing position under the bias of ratchet biasing member 132a (FIGS. 11-14). Accordingly, present lever 158 is operably coupled to the ratchet 132, and is shown being coupled to ratchet 132 via a rod or cable 63, by way of example and without limitation. During the presenting operation, drive shoulder 166b bypasses drive arm 160 of cinch/present driven lever 162 as a result of drive arm 166 having been pivoted away from its home position to its deployed position. Then, upon completion of the presenting/ice breaking operation, actuator 130 reverses direction to allow coupling lever 144 to return coupling lever 144 opposite the direction indicated by arrow 152 to its home position under the bias imparted by biasing member on coupling lever 144, and cinch/present lever 148 is returned to its home position, upon reversal of actuator 131, via the bias imparted on cinch/present over 148 by spring member 148a. Drive lever 166 is a single moveable element that is moved between either a cinching position (FIG. 16 to 19) or an ice breaking position (e.g. FIGS. 10, 11) or a disengaged position (FIG. 20) which also may correspond to the ice breaking position. Drive lever 166 is moveable away from a center disengaged position in one direction towards the cinching position, or away from the center disengaged position in another opposite direction to the ice breaking position. Therefore, the drive lever 166 may in the cinching position directly contact to move the ratchet 132 and indirectly move the ratchet 132 and not directly contact the ratchet 132 via the ice breaking assembly feature/member 156, 158, 63, 164.

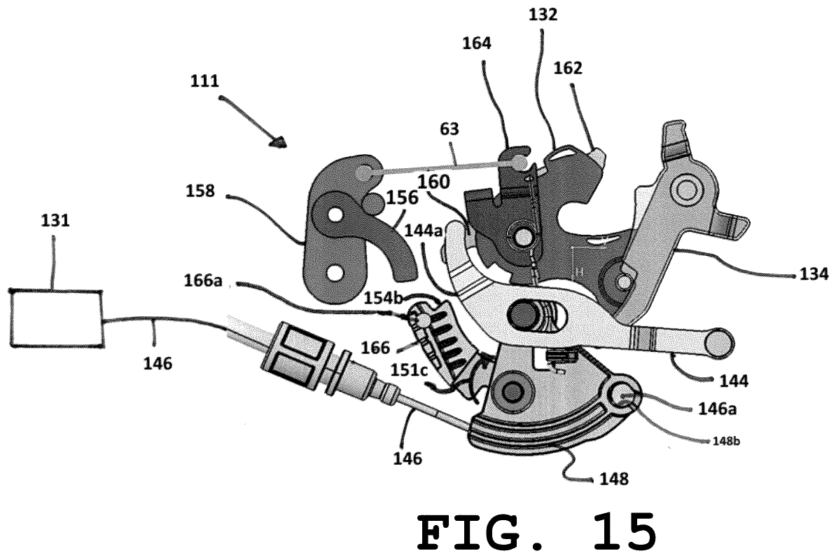

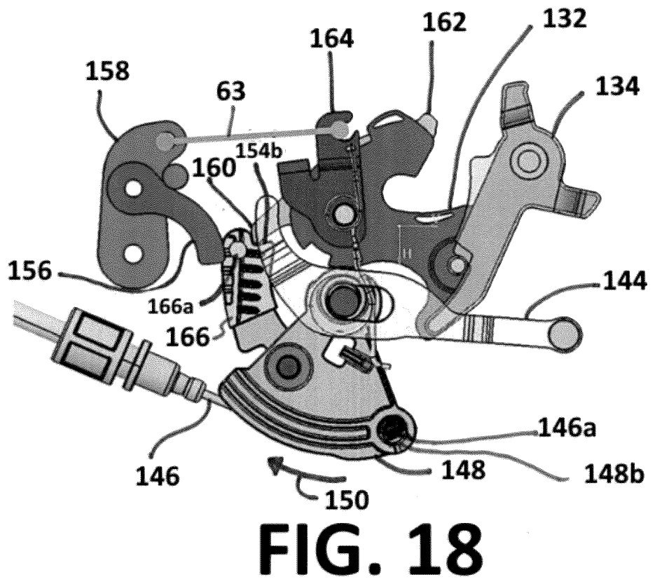

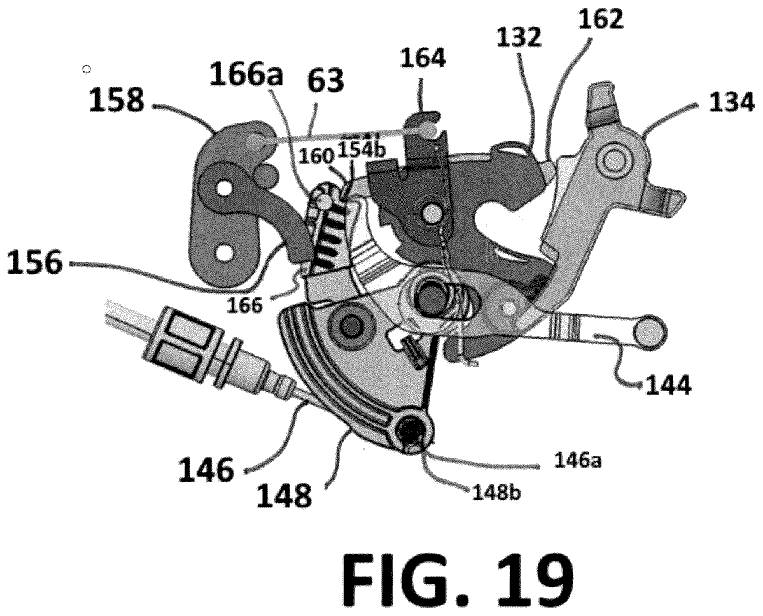

While being effective to perform the aforementioned presenting operation, cinch/present mechanism 111 also functions to perform a cinching operation via the single cable 146 and actuator 131, as shown in FIGS. 15-20. With coupling lever 144 returned under bias back to its home position, as discussed above, and with drive lever 166 returned under bias back to its home position by biasing member 166c, as shown in FIGS. 16-19, drive shoulder 166b is maintained in alignment with drive arm 160 for engagement with drive arm 160 of cinch driven lever 162. Thus, drive lever 166, while in its home position, is positioned for operable engagement with the ratchet 132. Then, activation of cinch/present actuator 131, such a via a signal from ECU, by way of example and without limitation, single cable 146, connected to cinch/present lever 148, such as via a cable ferrule 146a disposed in a ferrule pocket 148b of cinch/present lever 148, is pulled via actuator 131 and drivingly pivots cinch/present lever 148 in direction of arrow 150 (FIGS. 16-18), thereby moving drive shoulder 166b into driving engagement with arm 160 of cinch driven lever 162 of cinch/present mechanism 111 (FIG. 18). With drive lever 166 remaining in its home position under the bias imparted by biasing member 166c, drive pin 166a remains spaced from peripheral arcuate surface 144a of coupling lever 144 and bypasses the arm 156 extending from present lever 158, and thus, arm 156 of present lever 158 is not engaged by drive pin 166a, thereby causing present lever 158 to remain stationary during the cinching process. With drive shoulder 166b engaged with arm 160, cinch driven lever 162, with arm 160 being drivingly and fixedly coupled to ratchet 132 for conjoint movement therewith, is rotatably driven to forcibly drive ratchet 132 rotatably toward and ultimately to the primary striker capture position in the cinching operation (FIGS. 18 and 19). Then, upon completion of the cinching operation, actuator 131 is reversed, as discussed above for the presenting operation, and cinch/present lever 148 is returned to its home position via the bias imparted on cinch/present over 148 by spring member 148a. Accordingly, the drive arm 166 is pivotal relative to the cinch/present lever 148 between its home position, whereat the second drive feature 166b is positioned to drive the ratchet 132 to the striker capture position, and its deployed position, whereat the first drive feature 166a is positioned for driving engagement with the present lever 158.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a closure panel of a motor vehicle, comprising:
a latch mechanism having a pawl moveable from a ratchet holding position to a ratchet releasing position to cause a ratchet to move from a striker capture position, whereat the ratchet is in latched engagement with a striker to maintain the closure panel in a closed position, to a striker releasing position out of latched engagement from the striker to allow the closure panel to be moved from the closed position to an open position; and
at least one lever operable during a cinching operation to facilitate cinching the ratchet to the striker capture position and during an ice breaking operation to present the ratchet to the striker releasing position.

2. The latch assembly of claim 1, wherein the at least one lever is configured to move between a home position, whereat a link is moved to a first position for operable engagement with the ratchet to cinch the ratchet to the striker capture position, and a deployed position, whereat the link is moved to a second position in decoupled relation from the ratchet.

3. The latch assembly of claim 2, further including a cable operably coupled to the link.

4. The latch assembly of claim 3, further including a cinch/present lever coupled to the link, wherein the cable is directly coupled to the cinch/present lever.

5. The latch assembly of claim 4, further including a present lever operably coupled to the ratchet, wherein the cinch/present lever is arranged to operably drive the present lever and cause the ratchet to move to the striker releasing position.

6. The latch assembly of claim 5, wherein the present lever is coupled to the ratchet by a cable.

7. The latch assembly of claim 5, wherein the link has a first drive feature configured for driving engagement with the present lever.

8. The latch assembly of claim 7, wherein the link has a second drive feature configured drive the ratchet to the striker capture position.

9. The latch assembly of claim 8, wherein the link is pivotal relative to the cinch/present lever between a home position, whereat the second drive feature is positioned to drive the ratchet to the striker capture position, and a deployed position, whereat the first drive feature is positioned for driving engagement with the present lever.

10. The latch assembly of claim 9, wherein the link is biased toward the home position by a biasing member.

11. The latch assembly of claim 5, wherein the cinch/present lever is arranged in driving engagement with the present lever.

12. The latch assembly of claim 11, wherein the cinch/present lever and the present lever each have teeth arranged in meshed engagement with each other.

13. The latch assembly of claim 11, further including a coupling link configured to act on the ratchet to present the ratchet to the striker releasing position.

14. The latch assembly of claim 13, wherein the present lever has a slot and the coupling link has a drive member disposed in the slot for lost motion with the slot between a misaligned, disengaged position relative to a driven shoulder of the ratchet and into an aligned, engaged position with the driven shoulder of the ratchet.

15. The latch assembly of claim 14, wherein the link has a drive member configured for movement between a coupled position, whereat drive member is positioned for operable engagement with the ratchet to drivingly move the ratchet to the striker capture position, and a decoupled position, wherein drive member moved out from operable engagement with the ratchet.

16. The latch assembly of claim 15, wherein the drive member of the link is provided as a hook-shaped end of link.

17. The latch assembly of claim 15, wherein the at least one lever has a drive member configured for driving engagement with a driven surface of the link to move the drive member out from operable engagement with the ratchet.

18. The latch assembly of claim 17, wherein the drive member is a protrusion extending laterally from the at least one link and the driven surface is an elongate ledge extending laterally from the link.

19. The latch assembly of claim 14, wherein the at least one lever is configured for direct engagement with the pawl to move the pawl from the ratchet holding position to the ratchet releasing position.

20. The latch assembly of claim 19, further including a power release gear having a first cam operable to drive the at least one lever into direct engagement with the pawl to move the pawl from the ratchet holding position to the ratchet releasing position, and a second cam operable to drive the coupling link between the misaligned, disengaged position relative to a driven shoulder of the ratchet and the aligned, engaged position with the driven shoulder of the ratchet.
